(19) United States
(12) Patent Application Publication
(10) Pub. No.: US 2026/0002854 A1
(43) Pub. Date: Jan. 1, 2026

(54) SINGLE UNIT DEVICES FOR VISCOSITY AND LIGHT SCATTERING AND METHODS FOR THE SAME

(71) Applicant: TOSOH BIOSCIENCE LLC, King of Prussia, PA (US)

(72) Inventor: Michael P. Murphy, Cleveland, TX (US)

(21) Appl. No.: 18/880,703

(22) PCT Filed: Jun. 13, 2023
(86) PCT No.: PCT/US2023/025136

§ 371 Date: Jan. 2, 2025

Related U.S. Application Data
(60) Provisional application No. 63/358,348, filed on Jul. 5, 2022.

(51) Int. Cl. G01N 11/08; G01N 21/53

(52) U.S. Cl. CPC G01N 11/08; G01N 21/53

(57) ABSTRACT

Single unit devices for viscosity and light scattering, and methods for the same are disclosed. The single unit device may include an inlet line, first and second fluid flow lines in fluid communication with the inlet line, a light scattering detector (LSD), a pressure transducer line, a pressure transducer disposed fluidly coupled with the pressure transducer line, and an exit stream. The first fluid flow line may include first and second capillaries and a first tee connector interposed between the first and second capillaries. The second fluid flow line may include first and second capillaries and a second tee connector interposed between the first and second capillaries. The LSD may be disposed downstream the second tee connector and upstream the second capillary of the second fluid flow line. The exit stream may be in fluid communication with the respective second capillaries of the first and second fluid flow lines.

### CROSS-REFERENCE TO RELATED APPLICATIONS

This application claims priority to U.S. Provisional Patent Application No. 63/358,348, filed on Jul. 5, 2022, the contents of which are incorporated herein by reference to the extent consistent with the present disclosure.

### BACKGROUND

In liquid chromatography, such as size exclusion chromatography, experimental throughput is often determined or limited by the rate of sample preparation and separation, rather than by detection time. As such, it is conventional to place a plurality of detectors after the sample preparation and separation processes to efficiently and simultaneously obtain more property information from a single chromatographic run. Common detectors for measuring concentration and chemical species identification may include detectors for refractive index, ultra-violet absorption, infra-red absorption, or the like. Common detectors for measuring macromolecular microstructure may include viscosity and light scattering detectors, which generally require a companion concentration detector for referencing at each chromatographic data point. These detectors may be disposed in series or in parallel with one another. Since fluidics of liquid chromatography are maintained under laminar flow, respective signals for each of the successive detectors are broadened according to lines or flow paths (e.g., tubing) or detectors disposed upstream thereof. The relative signal time also needs to be adjusted for inter-detector fluidic delays. To address the phenomena of the signal broadening and the inter-detector fluidic delays, methods utilizing mathematical corrections (e.g., via algorithms) are often needed.

While these mathematical corrections are well established in the art of liquid chromatography, it is also well known that these mathematical corrections lead to the problematic lowering of chromatographic resolution. For example, the mathematical corrections may often include the convolution and offset of upstream detectors to match the broadest and subsequent or latest eluting detectors, which leads to the lowering of chromatographic resolution. Conversely, the deconvolution of detectors in the art of liquid chromatography is discouraged or taught away from due to the amplification of noise in conventional deconvolution processes.

In addition to the foregoing, it should be appreciated that disposing the detectors in series or in a series configuration has the disadvantage of additive detector broadening from downstream or subsequent detectors. Utilizing the series configuration may also result in difficulties in creating excessive back pressure on the upstream detectors. Further, some detectors, such as viscometers. may dilute sample concentrations. and some detectors, such as conventional refractometers, may have relatively large waste lines that may exacerbate the broadening. Disposing the detector in parallel or in a parallel configuration has the disadvantage of additional broadening over time due to the reduced flowrate in the parallel configuration. Further, flow through parallel lines may change over time due to defects (e.g., fouling) in one of the lines. The parallel configuration also often requires that the respective waste lines of each of the detectors be combined to avoid gravitational effects.

What is needed, then, are improved detectors for viscosity and light scattering for addressing the aforementioned technical problems.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The foregoing and/or other aspects and utilities embodied in the present disclosure may be achieved by providing a single unit device. The single unit device may include: an inlet line, a first fluid flow line, a second fluid flow line, a light scattering detector, a pressure transducer line, a pressure transducer, and/or an exit stream. The first fluid flow line may include a first capillary in direct fluid communication with the inlet line; a second capillary disposed in series with the first capillary; and a first tee connector interposed between the first and second capillaries of the first fluid flow line. The second fluid flow may be in fluid communication with the inlet. The second fluid flow line may include a first capillary in direct fluid communication with the inlet line; a second capillary disposed downstream the first capillary, and a second tee connector interposed between the first and second capillaries of the second fluid flow line. The light scattering detector may be disposed downstream the second tee connector and upstream the second capillary of the second fluid flow line. The pressure transducer line may fluidly couple the first tee connector with the second tee connector. The pressure transducer may be disposed and fluidly coupled with the pressure transducer line. The exit stream may be in fluid communication with the second capillary of the first fluid flow line and the second capillary of the second fluid flow line.

In at least one implementation, the single unit device may further include a dilution reservoir disposed downstream of the light scattering detector and upstream of the second capillary of the second fluid flow line.

In at least one implementation, the light scattering detector may include a sample cell, the sample cell may include: an inlet fluidly coupled with and disposed downstream of the first capillary of the second fluid flow line; and first and second outlets fluidly coupled with and disposed upstream of the second capillary of the second fluid flow line.

In at least one implementation, the sample cell may further include: a body defining a flowpath extending axially therethrough, the flowpath may include a cylindrical inner section interposed between a first outer section and a second outer section, wherein the first outer section is frustoconical, and a first end portion of the first outer section is in direct fluid communication with the inner section and has a cross-sectional area relatively less than a cross-sectional area at a second end portion thereof, wherein the body further defines the inlet in direct fluid communication with the inner section and configured to direct a sample to the inner section of the flowpath, and wherein the body further defines the first and second outlets, wherein the first outlet and the second outlet may be configured to fluidly couple the first and second outer sections with the exit stream via the second capillary of the second fluid flow line.

In at least one implementation, the second outer section of the sample cell may be frustoconical, and a first end portion of the second outer section may be in direct fluid communication with the inner section and may have a cross-sectional area relatively less than a cross-sectional area at a second end portion thereof.

In at least one implementation, the body may define a first recess extending axially therethrough, the first recess may be in fluid communication with the first outer section and configured to receive a first lens of the light scattering detector.

In at least one implementation, the body may define a second recess extending axially therethrough, the second recess may be in fluid communication with the second outer section and configured to receive a second lens of the light scattering detector.

In at least one implementation, the body of the sample cell may define an aperture extending radially therethrough, wherein the aperture may be in direct fluid communication with the inner section of the flowpath.

In at least one implementation, the single unit device may further include an optically transparent material disposed in the aperture.

In at least one implementation, the single unit device may further include one or more purge lines fluidly coupled with the pressure transducer and configured to purge the pressure transducer.

In at least one implementation, the single unit device may further include a respective purge valve disposed in each of the one or more purge lines, optionally, each of the one or more purge lines may be fluidly coupled with the exit stream.

In at least one implementation, the light scattering detector may further include a laser to emit a beam of light, wherein the flowpath of the sample cell may have a centerline aligned with the beam of light.

In at least one implementation, the light scattering detector may further include at least one detector operably coupled with the sample cell and configured to receive scattered light emitted from the sample cell.

The foregoing and/or other aspects and utilities embodied in the present disclosure may be achieved by providing a system including: the single unit device disclosed herein or according to any of the foregoing paragraphs, and a refractometer operably coupled with the single unit device.

In at least one implementation, the single unit device and the refractometer may be operably coupled with one another in series.

In at least one implementation, the refractometer may be disposed upstream of the single unit device.

The foregoing and/or other aspects and utilities embodied in the present disclosure may be achieved by providing a method of using any one of the systems disclosed herein, which may include the single unit device and the refractometer operably coupled with the single unit device. The method may include: flowing a sample through the refractometer; and flowing the sample through the single unit device.

In at least one implementation, flowing the sample through the single unit device may include flowing the sample from the inlet line to the exit stream via the first fluid flow line and the second fluid flow line.

In at least one implementation, flowing the sample through the second fluid flow line may include flowing the sample through the first and second capillaries of the second fluid flow line, and flowing the sample through the light scattering detector interposed between the first and second capillaries of the second fluid flow line.

In at least one implementation, the method may further include flowing the sample from the refractometer to the single unit device.

### BRIEF DESCRIPTION OF THE DRAWINGS

The accompanying drawings, which are incorporated in and constitute a part of this specification, illustrate varying implementations of the present disclosure. These and/or other aspects and advantages in the implementations of the disclosure will become apparent and more readily appreciated from the following description of the various implementations, taken in conjunction with the accompanying drawings. It should be noted that some details of the drawings have been simplified and are drawn to facilitate understanding of the present disclosure rather than to maintain strict structural accuracy, detail, and scale. These drawings/figures are intended to be explanatory and not restrictive.

FIG. 1 illustrates a schematic view of a conventional viscometer, according to the prior art.

FIG. 2A illustrates a schematic view of a conventional sample cell for a light scattering detector, according to the prior art.

FIG. 2B illustrates an enlarged view of the portion of the sample cell indicated by the box labeled 2B of FIG. 2A, according to the prior art.

FIG. 2C illustrates a schematic view of a light scattering detector (LSD) including a sample cell, according to the prior art.

FIG. 3 illustrates a schematic view of an exemplary combined or single unit device incorporating a viscometer and a light scattering detector, according to one or more implementations disclosed.

FIG. 4 illustrates a schematic view of another exemplary single unit device incorporating a viscometer and a light scattering detector, according to one or more implementations disclosed.

FIG. 5 illustrates a plot of the observed light scattering angles and the viscometer signal of Example 1.

FIG. 6 illustrates a schematic view of a comparative single unit device incorporating a viscometer and a light scattering detector.

FIG. 7 illustrates a plot of the observed signals of the right angle light scattering (RALS) detector and the viscometer of the comparative single unit device of FIG. 6.

FIG. 8 illustrates a plot of the observed signals of the right angle light scattering (RALS) detector and the viscometer of the single unit device of FIG. 4.

FIG. 9 illustrates a schematic view of a viscometer and a light scattering detector in a parallel configuration.

FIG. 10 illustrates a schematic view of a viscometer and a light scattering detector in a serial or series configuration.

FIG. 11 illustrates a schematic view of a viscometer and a light scattering detector in an exemplary single unit device configuration.

FIG. 12 illustrates a plot of the chromatic peaks observed in the parallel configuration of FIG. 9.

FIG. 13 illustrates a plot of the chromatic peaks observed in the series configuration of FIG. 10.

FIG. 14 illustrates a plot of the chromatic peaks observed with the single unit device configuration of FIG. 11.

### DETAILED DESCRIPTION

The following description of various typical aspect(s) is merely exemplary in nature and is in no way intended to limit the disclosure, its application, or uses.

As used throughout this disclosure, ranges are used as shorthand for describing each and every value that is within the range. It should be appreciated and understood that the description in a range format is merely for convenience and brevity, and should not be construed as an inflexible limitation on the scope of any embodiments or implementations disclosed herein. Accordingly, the disclosed range should be construed to have specifically disclosed all the possible subranges as well as individual numerical values within that range. As such, any value within the range may be selected as the terminus of the range. For example, description of a range such as from 1 to 5 should be considered to have specifically disclosed subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

All references cited herein are hereby incorporated by reference in their entireties. In the event of a conflict in a definition in the present disclosure and that of a cited reference, the present disclosure controls.

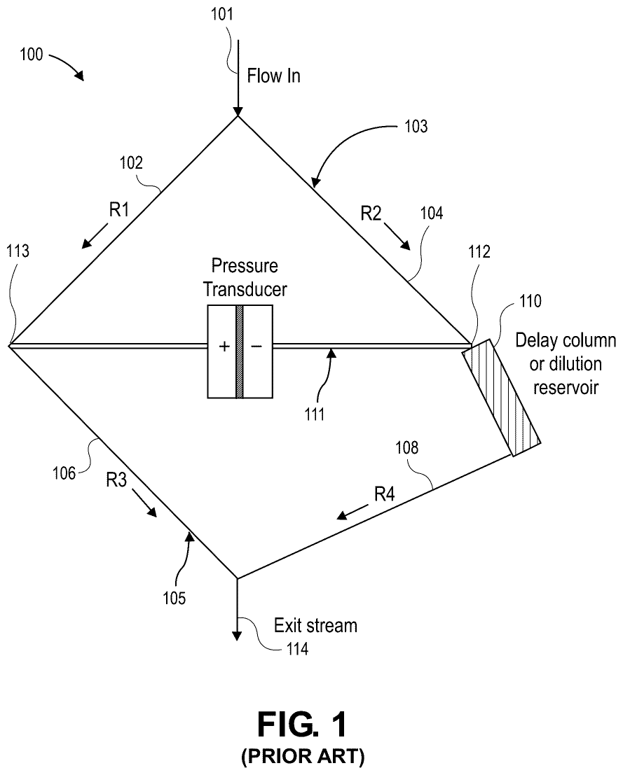

FIG. 1 illustrates a schematic view of a conventional viscometer 100, according to the prior art. The conventional viscometer 100 illustrated in FIG. 1 may also be referred to as a Wheatstone bridge viscometer 100, which is further described in detail in Haney, M. A. (1985). The Differential Viscometer. I. A New Approach to the Measurement of Specific Viscosities of Polymer Solutions. Journal of Applied Polymer Science, Vol. 30, 3023-3036., Haney, M. A. (1985). The Differential Viscometer. II. On-Line Viscosity Detector for Size-Exclusion Chromatography. Journal of Applied Polymer Science, Vol. 30, 3037-3049., and U.S. Pat. No. 4,463,598, Issued Aug. 7, 1984, the contents of which are incorporated herein to the extent consistent with the present disclosure.

As illustrated in FIG. 1, the conventional viscometer 100 may include an inlet 101 fluidly coupled with a plurality of capillaries R1-R4 (four are shown 102, 104, 106, 108). In at least one implementation, capillaries 102, 106 may form a first fluid flow line 105 and capillaries 104, 108 may form a second fluid flow line 103. The first fluid flow line 105 may include a “Tee” connection 113 interposed between the capillaries 102, 106. The second fluid flow line 103 may include a “Tee” connection 112 interposed between the capillaries 104, 108.

Any one or more of the capillaries 102, 104, 106, 108 may have equally matched resistance or may have a known mismatched resistance to any one or more of the remaining capillaries 102. 104, 106, 108. The conventional viscometer 100 of FIG. 1 may include a delay reservoir or a delay column 110 disposed downstream of the “Tee” connection 112. The delay reservoir 110 may be capable of or configured to delay a sample flowing through the viscometer 100 from entering a reference capillary 108, thereby causing a mismatch in measured resistance across or via a bridge or pressure transducer line 111 and/or the pressure transducer coupled with the line 111. It should be appreciated that an exit stream or outlet line 114 of the viscometer 100 may be diluted by about 50% concentration. It should further be appreciated that a sample broadening effect is observed in the conventional viscometer 100 due to the length of the capillaries 102, 104, 106, 108 and the flow split involved, which will generally broaden the eluent stream exiting the detector via the exit stream 114. In view of the foregoing, when the conventional viscometer 100 illustrated in FIG. 1 is utilized in a series or serial configuration, it is generally disposed towards or at the end of the series configuration so as to avoid the dilution and sample broadening effects.

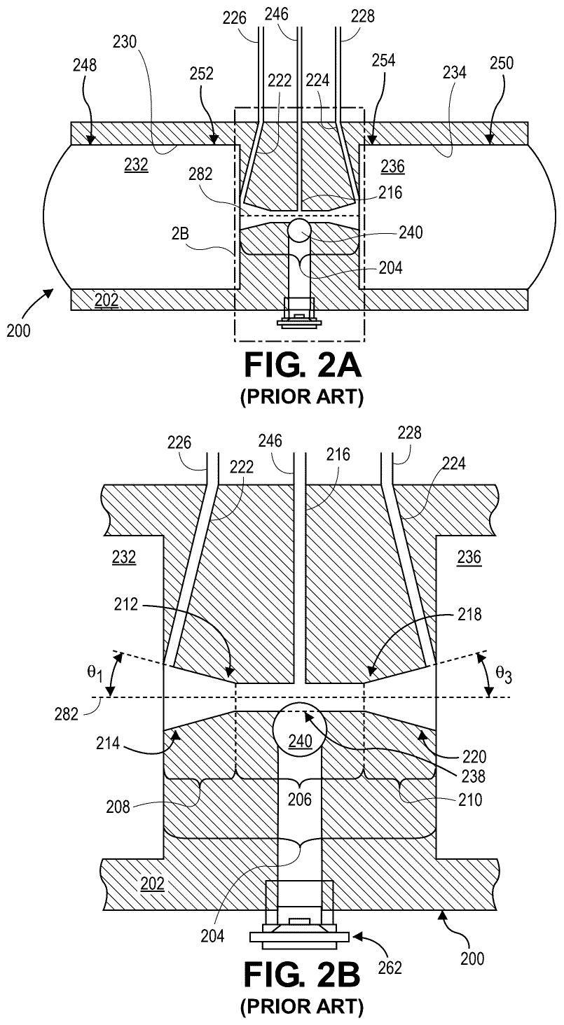

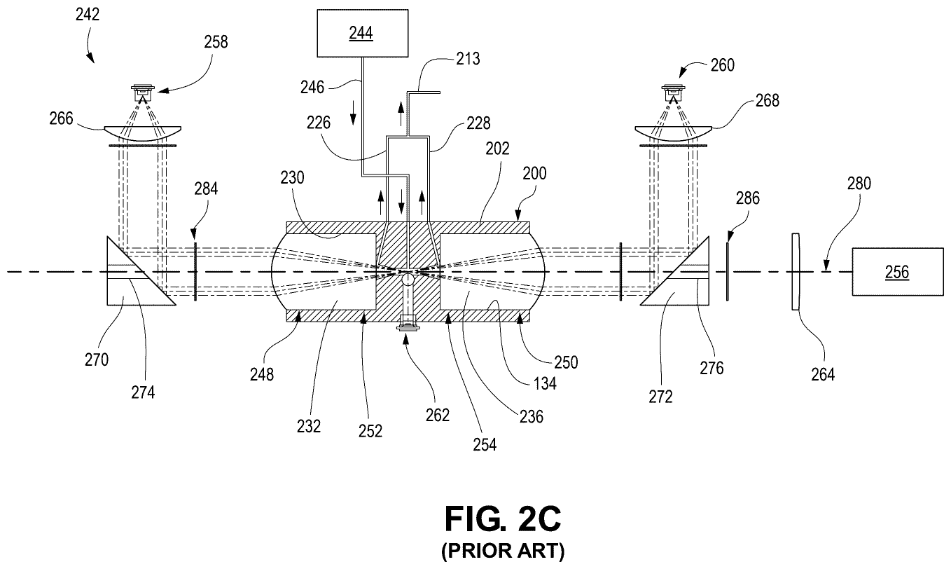

FIG. 2A illustrates a schematic view of a conventional sample cell 200 for a light scattering detector 242, according to the prior art. FIG. 2B illustrates an enlarged view of the portion of the sample cell 200 indicated by the box labeled 2B of FIG. 2A, according to the prior art. The conventional sample cell 200 and the light scattering detector 242 is further described in detail in Haney, Max. “Light Scattering Detectors and Sample Cells for the Same.” Patent Cooperation Treaty (PCT) PCT/US2019/012090, which was filed on Jan. 2, 2019, the contents of which are incorporated herein by reference to the extent consistent with the present disclosure. As illustrated in FIGS. 2A and 2B, the sample cell 200 may include a body 202 defining a flowpath 204 extending axially therethrough. The flowpath 204 may define a volume of the sample cell 200. The flowpath 204 may include a central axis or centerline 282 extending therethrough and configured to define a general orientation of the flowpath 204. As illustrated in FIG. 2B, the flowpath 204 and the central axis 282 thereof may be aligned or coaxial to a beam of light 280 emitted from a laser 256 of a light scattering detector 242. The flowpath 204 may include a cylindrical inner section 206 interposed between a first outer section 208 and a second outer section 210. The first outer section 208 may be frustoconical, and a first end portion 212 of the first outer section 208 may be in direct fluid communication with the inner section 206 and may have a cross-sectional area relatively less than a cross-sectional area at a second end portion 214 thereof. The body 202 may further define an inlet 216 in direct fluid communication with the inner section 206 and configured to direct a sample to the inner section 206, such as a middle of the inner section 206, of the flowpath 204. The second outer section 210 may be frustoconical, and a first end portion 218 of the second outer section 210 may be in direct fluid communication with the inner section 206 and may have a cross-sectional area relatively less than a cross-sectional area at a second end portion 220 thereof.

The body 202 may further define a first outlet 222 and a second outlet 224 extending therethrough. The first outlet 222 and the second outlet 224 may be configured to fluidly couple the respective second end portions 214, 220 of the first outer section 208 and second outer section 210 with a waste line or an outlet line 213 via a first outlet line 226 and a second outlet line 228, respectively. As illustrated in FIG. 2A, the body 202 may define a first recess 230 extending axially therethrough. The first recess 230 may be in fluid communication with the first outer section 208 and configured to receive a first lens 232 of the light scattering detector 242. The body 202 may define a second recess 234 extending axially therethrough. The second recess 234 may be in fluid communication with the second outer section 210 and configured to receive a second lens 236 of the light scattering detector 242. As illustrated in FIG. 2B, the body 202 may define an aperture 238 extending radially therethrough. The aperture 238 may be in direct fluid communication with the inner section 206, such as a middle of the inner section 206, of the flowpath 204. The sample cell 200 may further include an optically transparent material 240 disposed in the aperture 238.

In general, the sample cell 200 illustrated in FIGS. 2A and 2B may include a single inlet 216 and two outlets 226, 228. The two outlets may have matching flow or flowrates. The sample cell 200 of FIGS. 2A and 2B, at least, maximizes sensitivity while minimizing immediate band-broadening at the point of measurement. It should be appreciated that the conventional sample cell 200 illustrated in FIGS. 2A and 2B is not ideally utilized in a series configuration. For example, the waste line or outlet line 213 exiting the sample cell 200 may exhibit sample broadening. In view of the foregoing, when a light scattering detector 242 including the conventional sample cell 200 illustrated in FIGS. 2A and 2B is utilized in series, it is generally disposed towards or at the end of the series configuration.

FIG. 2C illustrates a schematic view of an exemplary light scattering detector (LSD) 242 including the sample cell 200 illustrated in FIG. 2A and 2B, according to the prior art. It should be appreciated that both static and dynamic light scattering detectors are contemplated. The LSD 242 may be operably coupled with a sample source or device 244, and capable of or configured to receive a sample or effluent therefrom. For example, as illustrated in FIG. 2C, the LSD 242 may be fluidly coupled with the sample source or device 244 via line 246 and configured to receive the effluent therefrom. Illustrative sample sources or devices 244 may include, but are not limited to, a chromatography instrument capable of or configured to separate one or more analytes of a sample or eluent from one another. For example, the sample source or device 244 may be a liquid chromatography instrument capable of or configured to separate the analytes of the eluent from one another based on their respective charges (e.g., ion exchange chromatography), sizes (e.g., size-exclusion or gel permeation chromatography), or the like, as is known in the art. In an exemplary implementation, the LSD 242 is operably coupled with a liquid chromatography instrument configured to separate the analytes from one another based on their respective sizes. For example, the LSD 242 is operably coupled with a liquid chromatography instrument including gel permeation chromatography columns.

The LSD 242 may include the exemplary sample cell 200, a collimated beam of light such, such as a laser 256, and one or more detectors 258, 260, 262 (three are shown) operably coupled with one another. The detectors 258, 260, 262 may be any suitable detector capable of or configured to receive analyte scattered light. For example, any one or more of the detectors 258, 260, 262 may be a photo-detector, such as a silicon photo-detector. The LSD 242 may include one or more lenses 232, 236, 264, 266, 268 (five are shown) capable of or configured to refract, focus, attenuate, and/or collect light transmitted through the LSD 242, and one or more mirrors 270, 272 (two are shown) capable of or configured to reflect or redirect the light transmitted through the LSD 242.

In at least one implementation, the first lens 232 and the second lens 236 may be disposed on opposing sides of the sample cell 200 and configured to refract, focus, attenuate, and/or collect light transmitted therethrough. In another implementation, illustrated in FIG. 2A and 2C, the body 202 of the sample cell 200 may define the first recess 230 and the second recess 234 extending longitudinally or axially therethrough, and configured to receive the first lens 232 and the second lens 236, respectively. As illustrated in FIGS. 2A and 2C, each of the first and second lenses 232, 236 may define a convex surface along respective first or outer end portions 248, 250 thereof. While the first end portions 248, 250 of the first and second lenses 232, 236 are illustrated as defining convex surfaces, it should be appreciated that any one of the respective first end portions 248, 250 of the first and second lenses 232, 236 may alternatively define a flat surface. As further illustrated in FIG. 2A, each of the first and second lenses 232, 236 may define a flat surface along respective second or inner end portions 252, 254 thereof. The respective second end portions 252, 254 of the first and second lenses 232, 236 may seal and/or at least partially define the flowpath 204 extending through the sample cell 200.

The laser 256 may be any suitable laser capable of or configured to provide a beam of light 280 having sufficient wavelength and/or power. For example, the laser 256 may be a diode laser, a solid state laser, or the like. The laser 256 may be configured to emit the beam of light 280 through the sample cell 200. For example, as illustrated in FIG. 2C, the laser 256 may be arranged or disposed about the LSD 242 such that the beam of light 280 emitted therefrom is transmitted through the sample cell 200. As further illustrated in FIG. 2C, a third lens 264 may be interposed between the sample cell 200 and the laser 256 and configured to focus the beam of light 280 directed to and through the sample cell 200.

In at least one implementation, at least one of the mirrors 270, 272 may be associated with a respective detector 258, 260, and configured to reflect or redirect the light (e.g., scattered light or analyte scattered light) towards the respective detector 258, 260. For example, as illustrated in FIG. 2C, a first mirror 270 may be disposed proximal the first lens 232 and configured to reflect at least a portion of the light from the first lens 232 towards a first detector 258. In another example, a second mirror 272 may be disposed proximal the second lens 236 and/or interposed between the second and third lenses 236, 264, and configured to reflect at least a portion of the light from the second lens 236 towards a second detector 260. In at least one implementation, one or more lenses 266, 268 may be interposed between the first and second mirrors 270, 272 and the first and second detectors 258, 260 to focus, refract, or otherwise direct the light from the mirrors 270, 272 to the detectors 258, 260. For example, as illustrated in FIG. 2C, a fourth lens 266 may be interposed between the first detector 258 and the first mirror 270, and a fifth lens 268 may be interposed between the second detector 260 and the second mirror 272.

In at least one implementation, at least one of the detectors 258, 260, 262 may be configured to receive the light (e.g., scattered light or analyte scattered light) from the sample cell 200 without the aid or reflection of one of the mirrors 270, 272. For example, as illustrated in FIGS. 2B and 2C, a third detector 262 may be disposed adjacent to or coupled with the sample cell 200 and configured to receive the light (e.g., scattered light) from the sample cell 200 at an angle of about 90° with respect to the beam of light 280. As further discussed herein, an optically transparent material or a sixth lens 240 may be configured to refract or direct the scattered light toward the third detector 262.

As illustrated in FIG. 2C, at least one of the sample cell 200, the first, the second, and the third lenses 232, 236, 264, and the first and second mirrors 270, 272 may be disposed parallel, coaxial, or otherwise aligned with one another along a direction of the beam of light 280 emitted by the laser 256. As further illustrated in FIG. 2C, each of the first and second detectors 258, 260 may be disposed or positioned to receive light (e.g., scattered light or analyte scattered light) from the respective mirrors 270, 272 in a direction generally perpendicular to the beam of light 280 emitted by the laser 256. Each of the first and second mirrors 270, 272 may define a respective bore or pathway 274, 276 extending therethrough. For example, the first mirror 270 may define a bore 274 extending therethrough in a direction parallel, coaxial, or otherwise aligned with the beam of light 280. Similarly, the second mirror 272 may define a bore 276 extending therethrough in the direction parallel, coaxial, or otherwise aligned with the beam of light 280. It should be appreciated that the bores 274, 276 extending through the respective mirrors 270, 272 may allow the beam of light 280 emitted from the laser 256 to be transmitted through the first and second mirrors 270, 272 to thereby prevent the beam of light 280 from being reflected towards the first and second detectors 258, 260.

In at least one implementation, the LSD 242 may include one or more screens or diaphragms 284, 286. For example, as illustrated in FIG. 2C, a first diaphragm may be interposed between the first lens 232 and the first mirror 270, and a second diaphragm may be interposed between the second mirror 272 and the lens 264. The diaphragms 284, 286 may be configured to “cleanup,” segregate, or otherwise filter stray light (e.g., halo of light) from the beam of light 280. For example, the diaphragm 284, 286 may define a hole or aperture (e.g., adjustable aperture/iris) capable of or configured to filter out stray light from the beam of light 280.

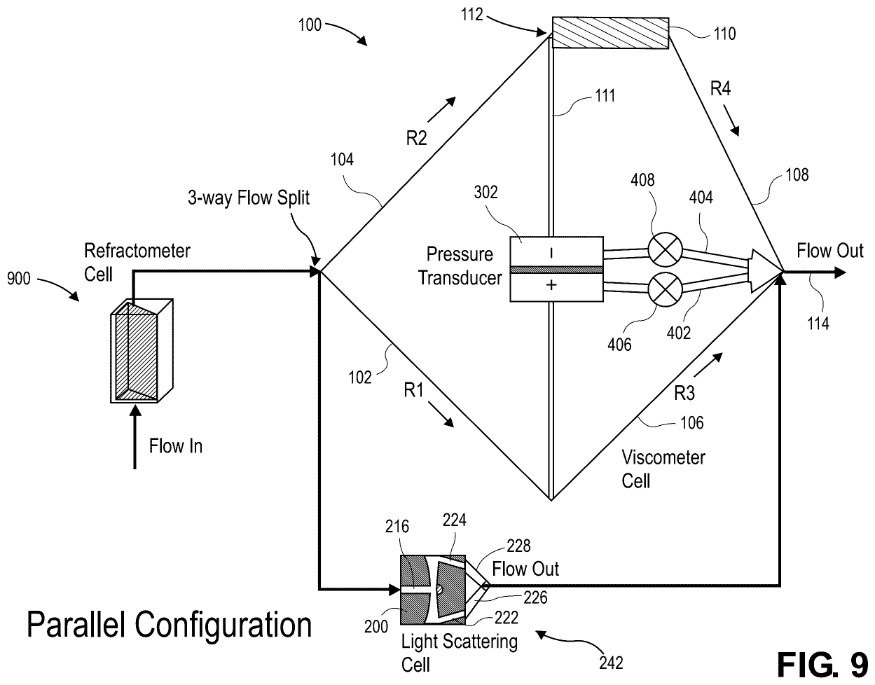

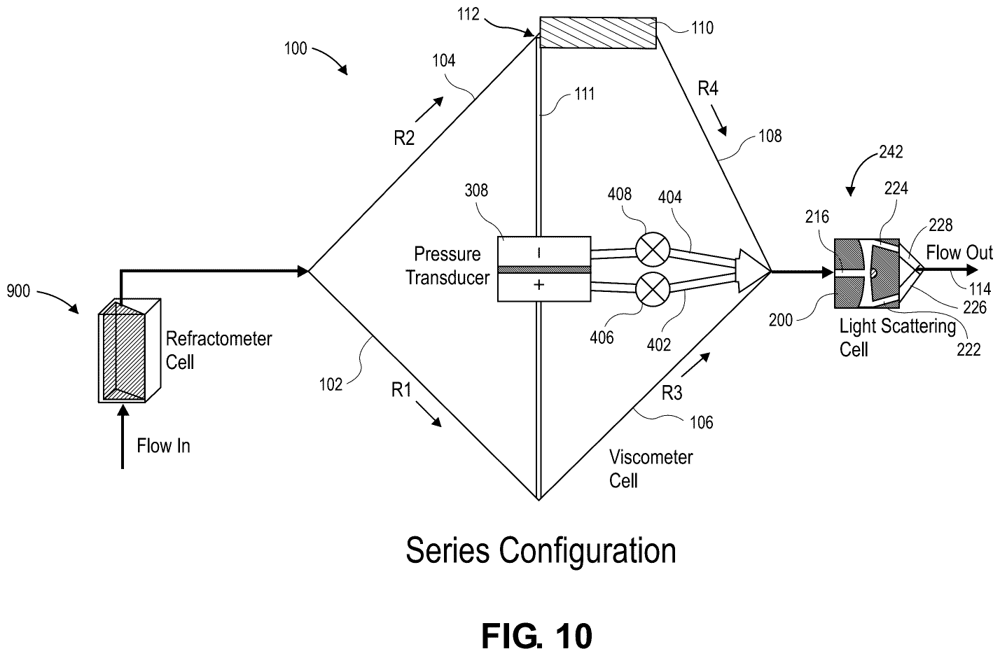

It should be appreciated that a viscometer, such as the conventional viscometer 100 illustrated in FIG. 1, and a light scattering detector, such as the light scattering detector 242 in FIG. 2C, are often utilized with a refractometer 900 (FIGS. 9 and 10). For example, the viscometer 100 and the light scattering detector 242 are often fluidly and/or operably coupled with a refractometer 900. Conventional methods of coupling the viscometer 100 and the light scattering detector 242 with the refractometer 900 often require a 3-way parallel flow split (as illustrated in FIG. 9) or a series configuration (as illustrated in FIG. 10). As is known in the art, a 3-way parallel flow split is relatively difficult to maintain and introduces the technical problem of increasing broadening of all three detectors (e.g., viscometer, light scattering detector, and refractometer). Further, as is known in the art, a series configuration of the three detectors would either dilute or broaden the downstream or later detectors.

In view of the foregoing, the present inventors have surprisingly and unexpectedly discovered that combining the viscometer 100 and the light scattering detector 242 into a combined or single unit 300, 400 or “cell” addresses the foregoing technical problems. Particularly, the present inventors have surprisingly and unexpectedly discovered that combining the viscometer 100 and the light scattering detector 242 into a single unit 300, 400 eliminates the need or requirement of a 3-way parallel flow split (FIG. 9). The present inventors have also surprisingly and unexpectedly discovered that the delay volume and peak shape of the viscometer 100 and the light scattering detector 242 are substantially matched or exhibit relatively closer matching when combining the viscometer 100 and the light scattering detector 242 into a single unit 300, 400 as disclosed herein, as compared to conventional methods of utilizing a serial or parallel configuration. The combined or single unit 300, 400 that combines the viscometer 100 and the light scattering detector 242 may be readily utilized in a series configuration with another detector, such as a UV detector (not shown). For example, the single unit 300, 400 may be utilized downstream of the UV detector in a series configuration. The single unit 300, 400 that combines the viscometer 100 and the light scattering detector 242 may also be readily utilized in a parallel configuration with another detector, such as a refractometer, for determining concentration.

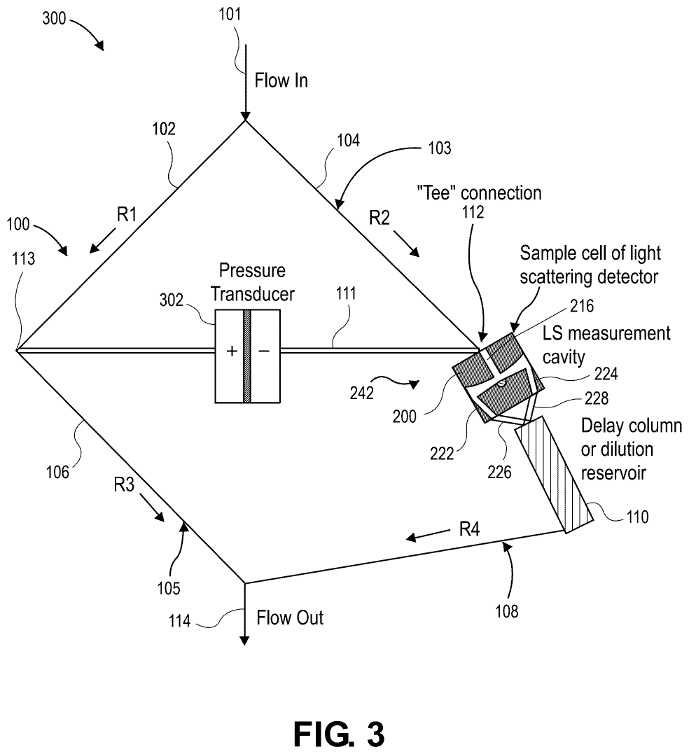

FIG. 3 illustrates a schematic view of an exemplary single unit device 300 incorporating a viscometer 100, a light scattering detector 242, and the sample cell 200 thereof, according to one or more implementations disclosed. The viscometer 100, the light scattering detector 242, and the sample cell 200 thereof may be similar in some respects to the viscometer 100, the light scattering detector 242, and the sample cell 200 described above; and therefore, may be best understood with reference to the description of FIGS. 1 and 2A-2C, where like numerals designate like components and will not be described again in detail. As illustrated in FIG. 3, the light scattering detector 242 is disposed downstream or after a “Tee” connection 112 that couples the sample flowing through capillary 104 to a pressure transducer 302 and capillary 108. The “Tee” connection 112 may also be referred to as a “Tee” connector or union. Illustrative “Tee” connectors may be or include, but are not limited to, Unions, Tees, and Crosses for High-Pressure HPLC Connections, which are commercially available from Thermo Fisher Scientific™ (Catalog Number: 03-052-437, 03-052-438, 03-170-306, or the like). As further illustrated in FIG. 3, the light scattering detector 242 is disposed upstream of a delay column or dilution reservoir 110. For simplicity, the sample cell 200 is utilized to also represent the LSD 242 and the sample cell 200 thereof in the schematic of FIG. 3. It was surprisingly and unexpectedly discovered that the particular location of the light scattering detector 242, particularly, the sample cell 200 thereof, as illustrated in FIG. 3, significantly affects the observed matched breadth of the viscometer 100. The surprising and unexpected results are demonstrated in the Examples below.

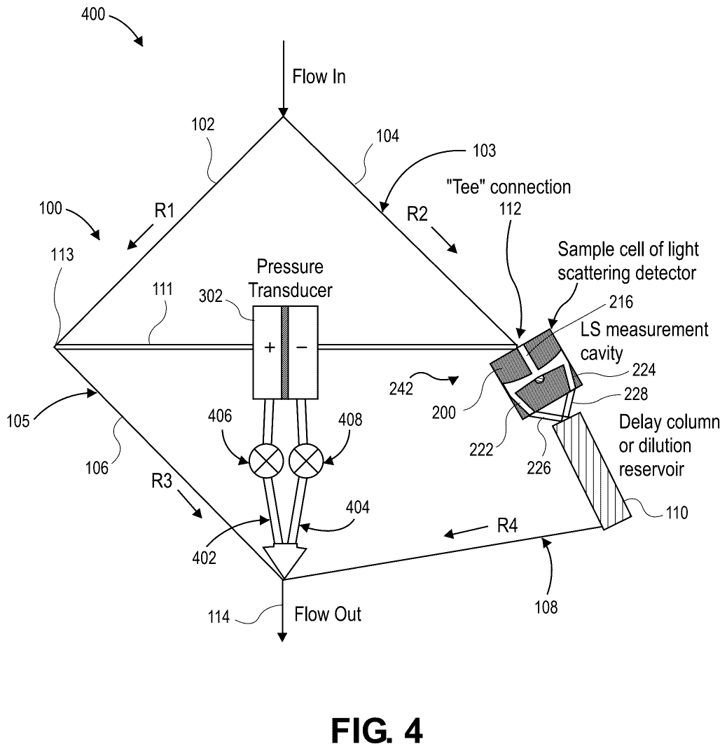

FIG. 4 illustrates a schematic view of another exemplary single unit device 400 incorporating a viscometer 100, a light scattering detector 242, and the sample cell 200 thereof, according to one or more implementations disclosed. The viscometer 100, the light scattering detector 242, and the sample cell 200 thereof may be similar in some respects to the viscometer 100, the light scattering detector 242, and the sample cell 200 described above; and therefore, may be best understood with reference to the description of FIGS. 1 and 2A-2C, where like numerals designate like components and will not be described again in detail. As illustrated in FIG. 4, the single unit device 400 can include one or more purge lines (two are shown 402, 404), each of the purge lines 402, 404 having at least one purge valve 406, 408 coupled therewith. The purge lines 402, 404 and purge valves 406, 408 coupled therewith may be capable of or configured to purge the pressure transducer 302 of the viscometer 100 without introducing any stagnant solvent into the sample cell 200 of the light scattering detector 242. Additionally, the purge lines 402, 404 and purge valves 406, 408 coupled therewith allow liquid or the sample to bypass the light scattering detector 242 and the sample cell thereof 200, thereby providing a means for changing solvents or conditioning columns. The purge lines 402, 404 and purge valves 406, 408 coupled therewith may also allow the changing of solvents and/or conditioning of columns while keeping the light scattering detector 242 free from air, fouling materials, and particulates. While FIG. 4 illustrates the purge lines 402, 404 coupled with the outlet 114, it should be appreciated that the purge lines 402, 404 may be fluidly coupled with any waste or outlet line capable of or configured to purge the transducer 302. It is not necessary for the purge lines 402, 404 to be in fluid communication with the common outlet 114.

The single unit devices 300, 400 described herein, which combine the viscometer 100, the light scattering detector 242, and/or the sample cell 200 thereof, and are illustrated in FIGS. 3 and 4, provide one or more of the following technical effects:
(1) minimizes peak broadening and offset between the viscometer 100 and the light scattering detector 242, as compared to conventional serial and parallel configurations of the viscometer and the light scattering detectors;
(2) minimizes conventional mathematical corrections, which are known for reducing resolution or introducing extraneous noise or artifacts, particularly when multi-detector ratioing is necessary;
(3) results in minimal or relatively smaller shape (e.g., peak) differences as compared to conventional means and methods;
(4) results in minimal or relatively smaller offset between the viscometer 100 and the light scattering detector 242 as compared to conventional configurations or methods of utilizing a viscometer and a light scattering detector (e.g., serial or parallel configurations);
(5) minimizes sample dilution in either the viscometer 100 or the light scattering detector 242;
(6) minimizes the possibility or chance of introducing particular matter into the light scattering detector 242, including when the viscometer detector 100 is purging the transducer 302 thereof;
(7) maintains constant or substantially constant backpressure on the light scattering detector 242 to minimize solvent outgassing from the sample cell 200 thereof while simultaneously not relying on adding more external tubing for flow split balancing or backpressure to other detectors as in a parallel configuration or a series configuration.
   Regarding technical effect (3), it should be appreciated to one having ordinary skill in the art that the “shape” of a chromatographic peak is defined or refers to the peak width at half-height (50% height). Further regarding the technical effect of (3) resulting in minimal or relatively smaller shape differences as compared to conventional means, such as compared to standard and series configurations, it is noted that the effect is more prominent or readily observable when the sample is a monodispersed standard injected into the liquid chromatograph.

While FIGS. 3 and 4 illustrate respective single unit devices 300, 400 utilizing a combination of an exemplary viscometer 100 and an exemplary light scattering detector 242, it should be appreciated that the light scattering detector 242 may be substituted and/or supplemented with any other suitable detector. For example, the light scattering detector 242 may be substituted and/or supplemented with any other suitable detector capable of or configured to provide any one or more of the technical effects disclosed herein. Illustrative detectors contemplated may be or include, but are not limited to, a refractive index (RI) detector, an ultraviolet (UV) detector, an infrared (IR) detector, a fluorescence detector, a conductivity detector, or the like, or a combination thereof.

The following numbered paragraphs disclose one or more exemplary variations of the subject matter of the application:
1. A single unit device, comprising: an inlet line; a first fluid flow line in fluid communication with the inlet line, the first fluid flow line comprising: a first capillary in direct fluid communication with the inlet line; a second capillary disposed in series with the first capillary; and a first tee connector interposed between the first and second capillaries of the first fluid flow line; a second fluid flow line in fluid communication with the inlet line, the second fluid flow line comprising: a first capillary in direct fluid communication with the inlet line; a second capillary disposed downstream the first capillary; a second tee connector interposed between the first and second capillaries of the second flow line; a light scattering detector disposed downstream the second tee connector and upstream the second capillary of the second fluid flow line; a pressure transducer line fluidly coupling the first tee connector with the second tee connector; a pressure transducer disposed in the pressure transducer line; an exit stream in fluid communication with the second capillary of the first fluid flow line and the second capillary of the second fluid flow line.
2. The single unit device of paragraph 1, further comprising a dilution reservoir disposed downstream of the light scattering detector and upstream of the second capillary of the second fluid flow line.
3. The single unit device of paragraph 1 or 2, wherein the light scattering detector comprises a sample cell, the sample cell comprising: an inlet fluidly coupled with and disposed downstream of the first capillary of the second fluid flow line; and first and second outlets fluidly coupled with and disposed upstream of the second capillary of the second fluid flow line.
4. The single unit device of paragraph 3, wherein the sample cell further comprises: a body defining a flowpath extending axially therethrough, the flowpath comprising a cylindrical inner section interposed between a first outer section and a second outer section, wherein the first outer section is frustoconical, and a first end portion of the first outer section is in direct fluid communication with the inner section and has a cross-sectional area relatively less than a cross-sectional area at a second end portion thereof, wherein the body further defines the inlet in direct fluid communication with the inner section and configured to direct a sample to the inner section of the flowpath, and wherein the body further defines the first and second outlets, wherein the first outlet and the second outlet are configured to fluidly couple the first and second outer sections with the exit stream via the second capillary of the second fluid flow line.
5. The single unit device of paragraph 4, wherein the second outer section of the sample cell is frustoconical, and a first end portion of the second outer section is in direct fluid communication with the inner section and has a cross-sectional area relatively less than a cross-sectional area at a second end portion thereof.
6. The single unit device of paragraph 4 or 5, wherein the body defines a first recess extending axially therethrough, the first recess in fluid communication with the first outer section and configured to receive a first lens of the light scattering detector.
7. The single unit device of paragraph 6, wherein the body defines a second recess extending axially therethrough, the second recess in fluid communication with the second outer section and configured to receive a second lens of the light scattering detector.
8. The single unit device of any of paragraphs 4-7, wherein the body of the sample cell defines an aperture extending radially therethrough, wherein the aperture is in direct fluid communication with the inner section of the flowpath.
9. The single unit device of paragraph 8, further comprising an optically transparent material disposed in the aperture.
10. The single unit device of any of paragraphs 1-9, further comprising one or more purge lines fluidly coupled with the pressure transducer and configured to purge the pressure transducer.
11. The single unit device of paragraph 10, further comprising a respective purge valve disposed in each of the one or more purge lines, optionally, each of the one or more purge lines fluidly coupled with the exit stream.
12. The single unit device of any of paragraphs 4-11, wherein the light scattering detector further comprises a laser to emit a beam of light, wherein the flowpath of the sample cell has a centerline aligned with the beam of light.
13. The single unit device of paragraph 12, wherein the light scattering detector further comprises at least one detector operably coupled with the sample cell and configured to receive scattered light emitted from the sample cell.
14. A system, comprising: the single unit device of any one of the foregoing paragraphs; and a refractometer operably coupled with the single unit device.
15. The system of paragraph 15, wherein the single unit device and the refractometer are operably coupled with one another in series.
16. The system of paragraph 14 or 15, wherein the refractometer is disposed upstream of the single unit device.
17. A method of using the system of any one of paragraphs 14-16, the method comprising: flowing a sample through the refractometer; and flowing the sample through the single unit device.
18. The method of paragraph 17, wherein flowing the sample through the single unit device comprises flowing the sample from the inlet line to the exit stream via the first fluid flow line and the second fluid flow line.
19. The method of paragraph 18, wherein flowing the sample through the second fluid flow line comprises flowing the sample through the first and second capillaries of the second fluid flow line, and flowing the sample through the light scattering detector interposed between the first and second capillaries of the second fluid flow line.
20. The method of any of paragraphs 17-19, further comprising flowing the sample from the refractometer to the single unit device.

### EXAMPLES

The examples and other implementations described herein are exemplary and not intended to be limiting in describing the full scope of compositions and methods of this disclosure. Equivalent changes, modifications and variations of specific implementations, materials, compositions and methods may be made within the scope of the present disclosure, with substantially similar results.

### Example 1

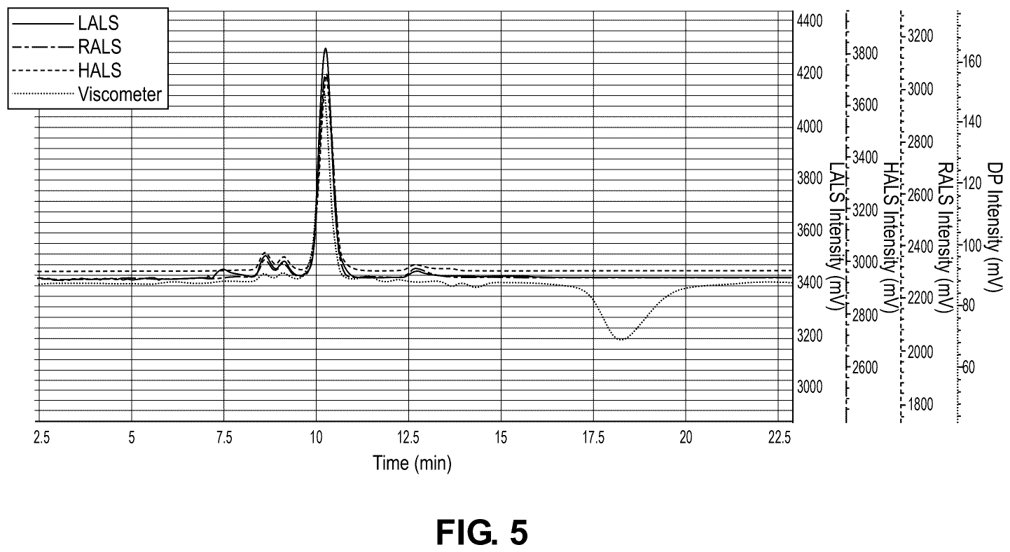

The single unit device 400 described in detail above and represented by FIG. 4 was utilized in measuring three light scattering angles and a viscometer signal. Particularly, the low angle light scattering (LALS), the right angle light scattering (RALS), and the high angle light scattering (HALS) were measured at about 10°, about 90°, and about 170°, respectively. The sample utilized was a narrow polystyrene standard having a nominal molecular weight of about 96,100 Da, which is commercially available from Tosoh Bioscience, LLC. of King of Prussia, PA. The sample utilized tetrahydrofuran (THF) as a solvent at a concentration of about 1.05 mg/mL. The conditions for operating the single unit device 400 were as follows: injection volume of about 100 μL, flow rate of about 1 mL/min, and utilizing Chromatography Column GMHHR-H, which is commercially available from Tosoh Bioscience, LLC. FIG. 5 illustrates a plot of the measurements. As illustrated in FIG. 5, all of the three observed light scattering angles and the observed viscometer signal exhibited simultaneous or substantially simultaneous measurements with the same or substantially the same shape. It should be appreciated that the observed light scattering angles and the viscometer signal illustrated in FIG. 5 are raw signals. Said in another way, the observed light scattering angles and the viscometer signal are raw signals that have not been smoothed, deconvoluted, shifted, or otherwise manipulated.

### Example 2

It should be appreciated that one having ordinary skill in the art can sufficiently define chromatographic peak shape of a monodispersed component numerically by describing the peak width at half-height (50% height). It should also be appreciated that one having ordinary skill in the art can sufficiently measure tailing by measuring the peak width at ⅕ height (20% height).

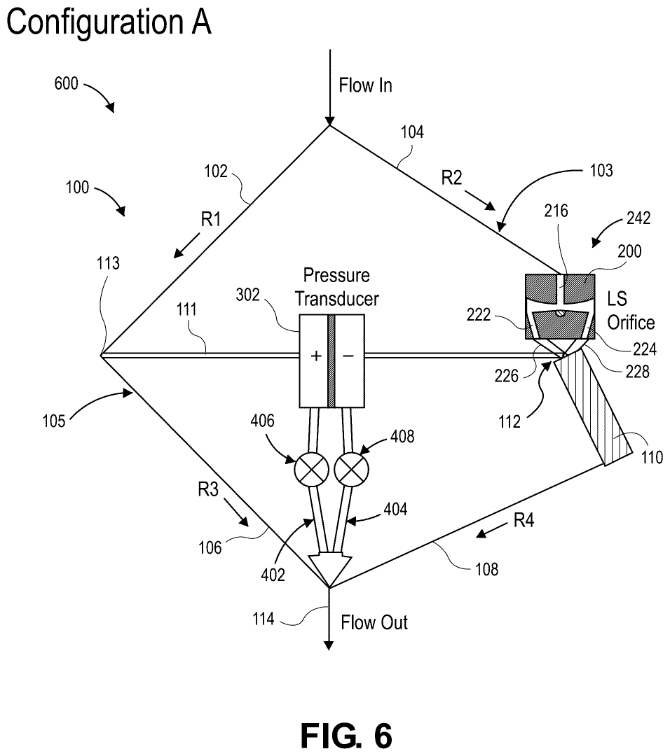

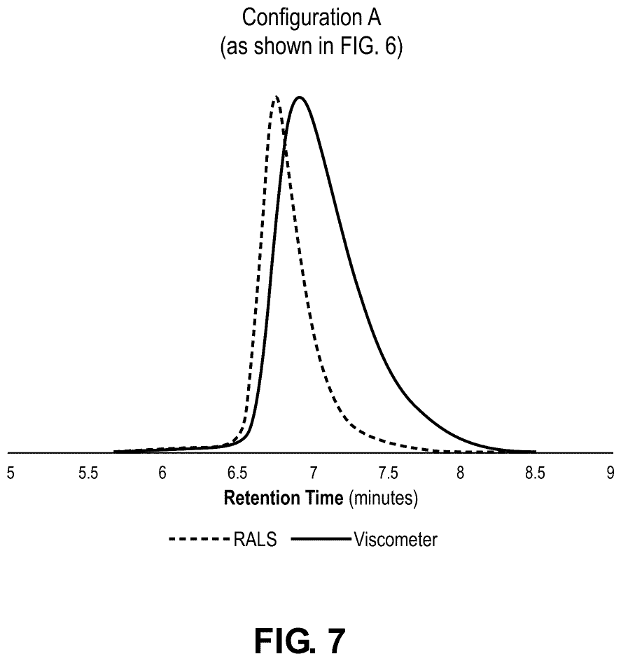

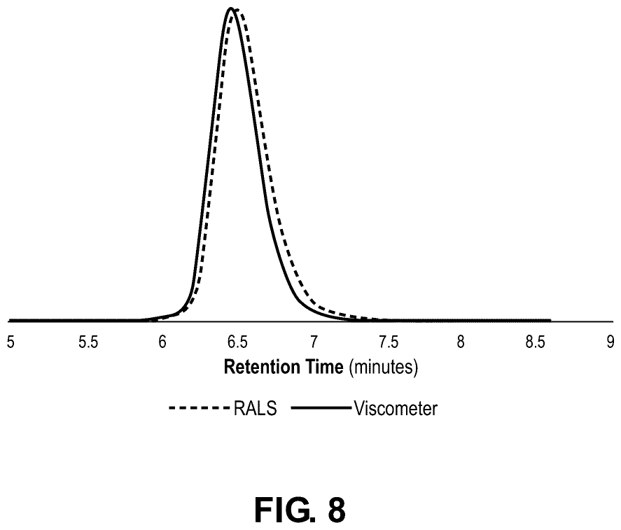

A comparative single unit device having a configuration different from the single unit device 400 of Example 1 was evaluated. Specifically, a comparative single unit device 600 incorporating the viscometer 100 and the light scattering detector 242 and having Configuration A, as illustrated in FIG. 6 was tested and compared to the exemplary single unit device 400 of Example 1 and illustrated in FIG. 4. The viscometer 100, the light scattering detector 242, and the sample cell 200 of FIG. 6 may be similar in some respects to the viscometer 100, the light scattering detector 242, and the sample cell 200 described above; and therefore, may be best understood with reference to the description of FIGS. 1, 2A-2C, 3, and 4, where like numerals designate like components and will not be described again in detail. As illustrated in FIG. 6, the light scattering detector 242 and the sample cell 200 thereof was placed after or downstream capillary 104 and before or upstream the T-fitting 112. The viscometer detector 100 and the right angle light scattering (RALS) detector 262 were simultaneously monitored and the baseline subtracted. The results of the comparative single unit device 600 and the exemplary single unit device 400 of Example 1 are shown in FIG. 7 and FIG. 8, respectively. Respective differences or deltas (A) in each of the peak widths at 50% (e.g., shape), 20% (e.g., tailing), and deltas of peak retention volumes of the comparative single unit device 600 and the exemplary single unit device 400 of Example 1 (FIG. 4) are summarized in Table 1 below.

TABLE 1

| Difference from | | Single Unit Device |
|---|---|---|
| RALS (Δ) | Configuration A | of Example 1 |
| Width at 50% Height | 0.209 | −0.013 |
| Width at 20% Height | 0.378 | −0.030 |
| Peak Retention Volume | 0.172 | −0.064 |

As illustrated in Table 1 and FIGS. 7 and 8, numerically and visually, there was a significant, surprising, and unexpected improvement in peak elution shape and synchronization of peak time in the exemplary single unit device 400 of Example 1 (FIG. 4), thereby favoring the placement of the light scattering detector 242 and the sample cell 200 thereof in the configuration illustrated in FIGS. 3 and 4.

### Example 3

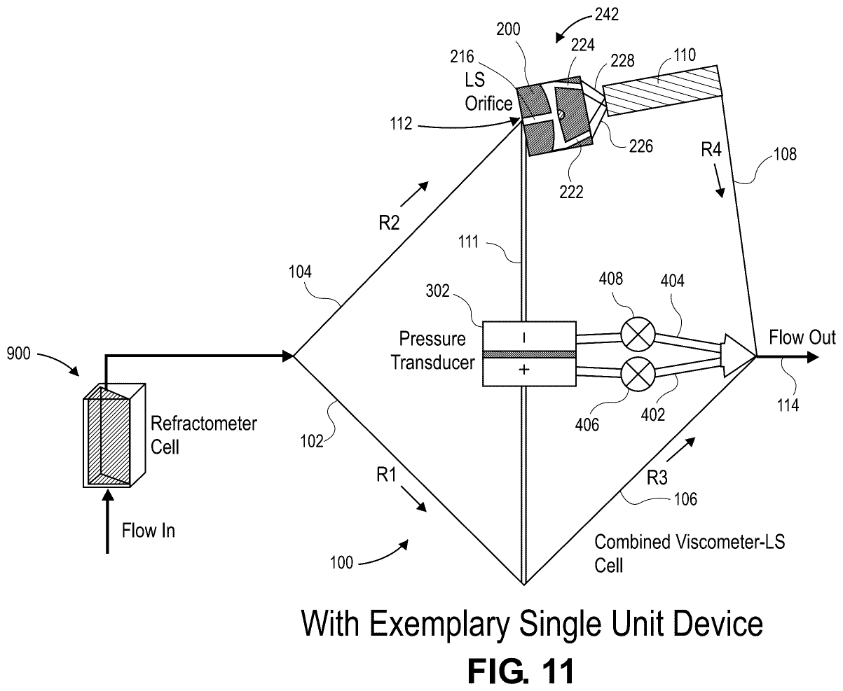

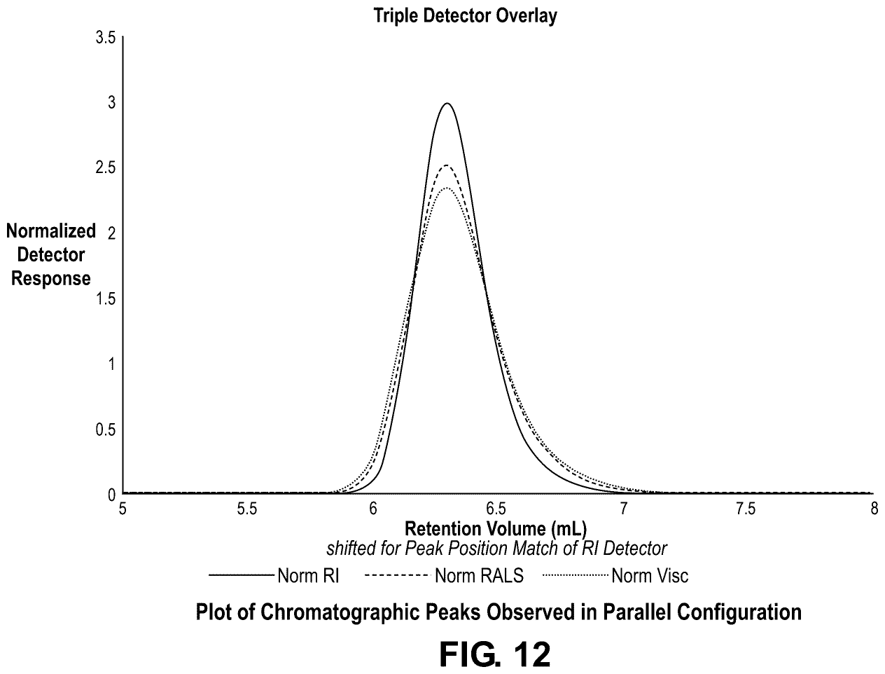

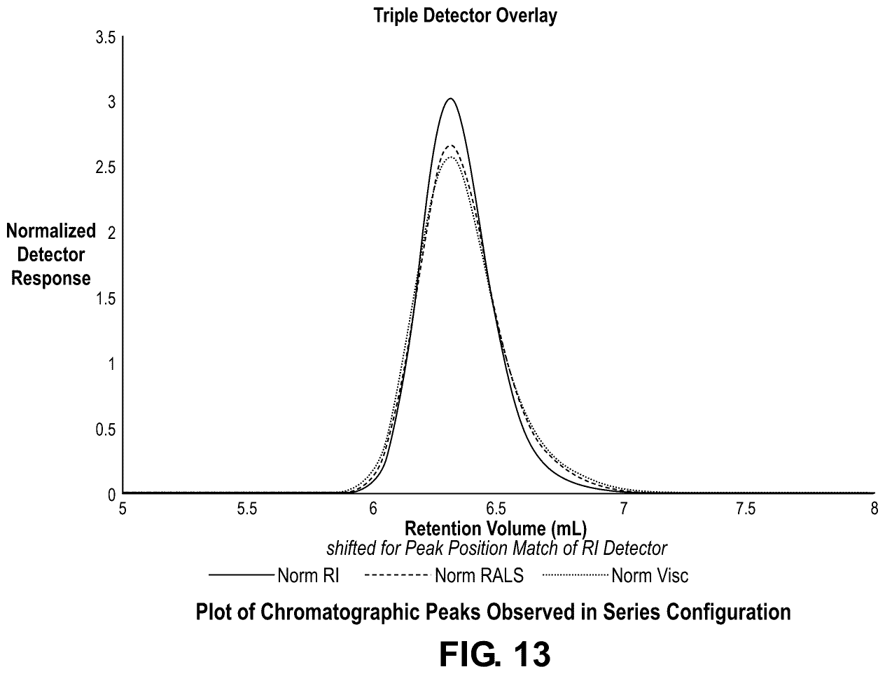

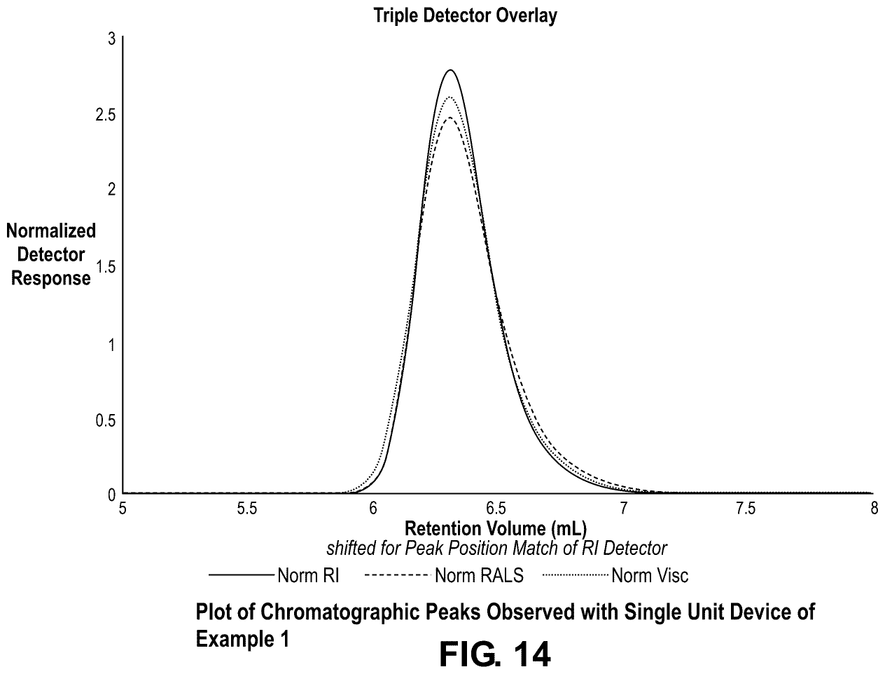

To compare series/serial, parallel, and combined configurations, a refractometer was placed in series before the parallel and serial configurations, to serve as a reference detector. Comparisons were conducted with the same light scattering detector 242 and viscometer 100 configured as: (1) parallel detectors (as shown in FIG. 9); (2) series/serial detectors with the viscometer 100 first (as shown in FIGS. 10); and (3) with the “Combined” configuration utilizing the exemplary single unit device 400 of the present disclosure (as shown in FIG. 11). The results are summarized below in Table 2. The respective plot of the chromatic peaks observed/measured in each of the parallel configuration, the series configuration, and the combined configuration, is illustrated in FIG. 12, FIG. 13, and FIG. 14, respectively.

TABLE 2

| Difference from | | | |
|---|---|---|---|
| RI (Δ) | Parallel | Series | Combined |
| Viscometer Width at 50% Height | 0.083 | 0.049 | 0.024 |
| RALS Width at 50% Height | 0.056 | 0.038 | 0.037 |
| Average Width at 50% Height | 0.069 | 0.044 | 0.031 |
| Viscometer Width at 20% Height | 0.136 | 0.083 | 0.035 |
| RALS Width at 20% Height | 0.094 | 0.066 | 0.065 |
| Average Width at 20% Height | 0.115 | 0.075 | 0.050 |
| Viscometer Peak Retention Volume | 0.313 | 0.183 | 0.183 |
| RALS Peak Retention Volume | 0.297 | 0.215 | 0.219 |
| Average Peak Retention Volume | 0.305 | 0.199 | 0.201 |
| Viscometer Area | 35.99 | 77.63 | 70.38 |
| RALS Area | 2268 | 1163 | 2340 |
| Average Peak Retention Volume | 0.305 | 0.199 | 0.201 |

It should be noted that the refractometer detector cell volume and outlet tubing was approximately 150 μL, which accounts for much of the observed delay volume shown in Table 2. It was observed that there was significant, surprising, and unexpected improvement in average detector shape in the “combined” configuration (as shown in FIG. 14) as compared to the reference refractometer. The average retention volume shift was similar to that of a series configuration, but with the advantage that there was no reduction in RALS Area. The combined configuration is further advantaged over the parallel configuration which has approximately half of the recovered Viscometer Area due to the reduced flow rate in parallel. Therefore utilizing the “combined configuration” or the exemplary single unit device 400 provided the maximum signal and recovered the best or closest peak shape relative to the refractive index detector.

The present disclosure has been described with reference to exemplary implementations. Although a limited number of implementations have been shown and described, it will be appreciated by those skilled in the art that changes may be made in these implementations without departing from the principles and spirit of the preceding detailed description. It is intended that the present disclosure be construed as including all such modifications and alterations insofar as they come within the scope of the appended claims or the equivalents thereof.

What is claimed is:

1. A single unit device, comprising:
an inlet line;
a first fluid flow line in fluid communication with the inlet line, the first fluid flow line comprising:
a first capillary in direct fluid communication with the inlet line;
a second capillary disposed in series with the first capillary; and
a first tee connector interposed between the first and second capillaries of the first fluid flow line;
a second fluid flow line in fluid communication with the inlet line, the second fluid flow line comprising:
a first capillary in direct fluid communication with the inlet line;
a second capillary disposed downstream the first capillary;
a second tee connector interposed between the first and second capillaries of the second flow line;
a light scattering detector disposed downstream the second tee connector and upstream the second capillary of the second fluid flow line;
a pressure transducer line fluidly coupling the first tee connector with the second tee connector;
a pressure transducer disposed in the pressure transducer line;
an exit stream in fluid communication with the second capillary of the first fluid flow line and the second capillary of the second fluid flow line.

2. The single unit device of claim 1, further comprising a dilution reservoir disposed downstream of the light scattering detector and upstream of the second capillary of the second fluid flow line.

3. The single unit device of claim 1 or 2, wherein the light scattering detector comprises a sample cell, the sample cell comprising:
an inlet fluidly coupled with and disposed downstream of the first capillary of the second fluid flow line; and
first and second outlets fluidly coupled with and disposed upstream of the second capillary of the second fluid flow line.

4. The single unit device of claim 3, wherein the sample cell further comprises:
a body defining a flowpath extending axially therethrough, the flowpath comprising a cylindrical inner section interposed between a first outer section and a second outer section,
wherein the first outer section is frustoconical, and a first end portion of the first outer section is in direct fluid communication with the inner section and has a cross-sectional area relatively less than a cross-sectional area at a second end portion thereof,
wherein the body further defines the inlet in direct fluid communication with the inner section and configured to direct a sample to the inner section of the flowpath, and
wherein the body further defines the first and second outlets, wherein the first outlet and the second outlet are configured to fluidly couple the first and second outer sections with the exit stream via the second capillary of the second fluid flow line.

5. The single unit device of claim 4, wherein the second outer section of the sample cell is frustoconical, and a first end portion of the second outer section is in direct fluid communication with the inner section and has a cross-sectional area relatively less than a cross-sectional area at a second end portion thereof.

6. The single unit device of claim 4 or 5, wherein the body defines a first recess extending axially therethrough, the first recess in fluid communication with the first outer section and configured to receive a first lens of the light scattering detector.

7. The single unit device of claim 6, wherein the body defines a second recess extending axially therethrough, the second recess in fluid communication with the second outer section and configured to receive a second lens of the light scattering detector.

8. The single unit device of any of claims 4-7, wherein the body of the sample cell defines an aperture extending radially therethrough, wherein the aperture is in direct fluid communication with the inner section of the flowpath.

9. The single unit device of claim 8, further comprising an optically transparent material disposed in the aperture.

10. The single unit device of any of the foregoing claims, further comprising one or more purge lines fluidly coupled with the pressure transducer and configured to purge the pressure transducer.

11. The single unit device of claim 10, further comprising a respective purge valve disposed in each of the one or more purge lines, optionally, each of the one or more purge lines fluidly coupled with the exit stream.

12. The single unit device of any of claims 4-11, wherein the light scattering detector further comprises a laser to emit a beam of light, wherein the flowpath of the sample cell has a centerline aligned with the beam of light.

13. The single unit device of claim 12, wherein the light scattering detector further comprises at least one detector operably coupled with the sample cell and configured to receive scattered light emitted from the sample cell.

14. A system, comprising:
the single unit device of any one of the foregoing claims; and
a refractometer operably coupled with the single unit device.

15. The system of claim 15, wherein the single unit device and the refractometer are operably coupled with one another in series.

16. The system of claim 14 or 15, wherein the refractometer is disposed upstream of the single unit device.

17. A method of using the system of any one of claims 14-16, the method comprising:
flowing a sample through the refractometer; and
flowing the sample through the single unit device.

18. The method of claim 17, wherein flowing the sample through the single unit device comprises flowing the sample from the inlet line to the exit stream via the first fluid flow line and the second fluid flow line.

19. The method of claim 18, wherein flowing the sample through the second fluid flow line comprises flowing the sample through the first and second capillaries of the second fluid flow line, and flowing the sample through the light scattering detector interposed between the first and second capillaries of the second fluid flow line.

20. The method of any of claims 17-19, further comprising flowing the sample from the refractometer to the single unit device.
